(19) United States
(12) Patent Application Publication
(10) Pub. No.: US 2010/0146014 A1
(43) Pub. Date: Jun. 10, 2010

(54) EXTENDABLE BUSINESS TYPE SYSTEM IN A PERFORMANCE MANAGEMENT PLATFORM

(75) Inventors: Marius Ionescu, Bellevue, WA (US); Kevin P. White, Seattle, WA (US); George Randy Dong, Issaquah, WA (US); Mark Xiaohong Yang, Sammamish, WA (US); Luming Wang, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/328,169

(22) Filed: Dec. 4, 2008

(51) Int. Cl. G06F 17/30; G06F 7/00

(52) U.S. Cl. 707/810; 707/E17.009

(57) ABSTRACT

Architecture for operating an industrial solution on top of a performance management platform using a custom business type library. The platform can plug/unplug the custom business type library, interacts with the type library to ensure data integrity and enforce business rules, and simplifies localizations of the industrial solution. The custom type library extends the capability to define specific behavior for models and dimensions, and create and define content specific to any industry, reuse, and packaging. The custom type library inherits from a generic type library of the platform. The customized type library defines business object types and associates business rules therewith. Through a common interface, the performance management platform can iterate through the business rule chains and enforce/apply the business rules during the operations.

### BACKGROUND

Software vendors attempt to provide application capabilities that address most common scenarios and end-user requirements. However, end-user requirements can continually evolve that exceed the supplied capabilities in the vendor application. In performance management platforms, for example, it is desired to deliver precise pre-packaged complete industrial solutions to address business requirements. A dominant request from end-users includes is the ability to define custom models and types in the business system. Unfortunately, schemas, business rules, and other application attributes are typically hard-coded to particular environments making it difficult to employ the application for other uses. Accordingly, the inability to provide a path for end-user customization of the application capabilities can impact vendor sales as the end-user may seek out compatible third-party alternatives to achieve the desired capability, or abandon the vendor application entirely for a new solution. Thus, the lack of foresight to provide a suitable path for end-user extensions to the application capabilities can greatly impact the bottom-line, future sales, and reputation of the software vendor.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

To that end, disclosed is architecture that increases the deployment and sale of an application (e.g., performance management server) by supplying a software product that allows the end-user to create custom solutions and third-party vendors to create custom vertical business applications.

The architecture packages and delivers an industrial solution using a custom business type library. A performance management platform, for example, can plug/unplug the type library. The performance management platform interacts with the type library to ensure data integrity and enforce business rules. The type library simplifies localizations of an industrial solution. Extending the custom type library allows users to define specific behavior for models and dimensions, and the ability to create and define content specific to any industry, reuse, and packaging.

The customized type library inherits from a generic type library of a performance management platform, which contains the generic object type and definition. The customized type library can define its own business object types and associate business rules therewith. Through a common interface, the performance management platform can iterate through the business rule chains and enforce/apply the business rules during the operations.

The architecture allows for the creation, packaging, and deployment of custom-created vertical applications, thereby reducing implementation time and facilitating opportunities for the application to be utilized by end-users and sold through third-party vendors for industry specific business applications. By industry, vertical applications include banking and financial services, insurance, education, defense, government, manufacturing, supply chain, and so on. A complete industrial solution can include business modeling, business rules and report templates.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a business customization system in accordance with the disclosed architecture.

FIG. 2 illustrates an alternative system that further employs a validation component.

FIG. 3 illustrates a class diagram for the custom type library content.

FIG. 4 illustrates table storage schema for the custom type library.

FIG. 5 illustrates a method of providing customized industrial application.

FIG. 6 illustrates a method of creating metadata based on a type.

FIG. 7 illustrates a method of validating metadata when received.

FIG. 8 illustrates a method of deploying a custom type library in accordance with the disclosed architecture.

FIG. 9 illustrates a block diagram of a computing system operable to execute custom type library processes in accordance with the disclosed architecture.

FIG. 10 illustrates a schematic block diagram of a computing environment that supports a vertical industrial solution on a performance management platform.

### DETAILED DESCRIPTION

Disclosed is architecture that increases the deployment and sale of an application (e.g., performance management server) by supplying a software product that allows the end-user to implement custom solutions and third-party vendors to create custom vertical solutions. The architecture allows for the creation, packaging, and deployment of custom-created vertical applications, thereby reducing implementation time and facilitating opportunities for the application to be utilized by end-users and sold through third-party vendors for industry specific planning applications. By industry, there are banking and financial Services, insurance, education, defense, government, manufacturing, supply chain, and so on.

A complete industrial solution can include business modeling, business rules and rule order, and report templates. The architecture packages and delivers an industrial solution using a Type Library. A performance management platform, for example, can plug/unplug the Type Library. The performance management platform interacts with the Type Library to ensure data integrity and enforce business rules. The Type Library simplifies localizations of an industrial solution. Extending the custom library allows users to define specific performance management platform behavior for models and dimensions, and the ability to create and define content specific to any industry, reuse, and packaging.

Accordingly, end-users and third-party vendors are now provided the capability to create customized system models with rich business rules and report templates that allow more rapid implementations of industry solutions. System-defined custom types can be created in the performance management planning systems, for example.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

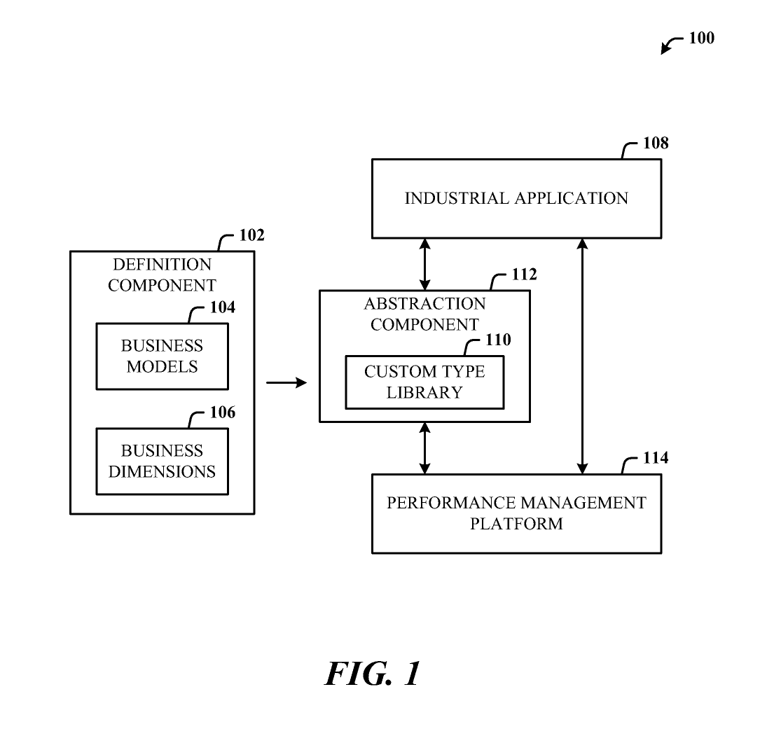

FIG. 1 illustrates a business customization system 100 in accordance with the disclosed architecture. The system 100 includes a definition component 102 for declaratively defining business models 104 and business dimensions 106 for an industrial application 108 as a custom type library 110 (e.g., business). An abstraction component 112 is provided for operating the industrial application 108 on top of a performance management platform 114 by seamlessly exposing functionality of the performance management platform 114 to the industrial application 108 via the custom type library 110.

The definition component facilitates declaration of a model type, model properties, business rules, and business templates for the models 104. The definition component 102 also facilitates the declaration of dimension attributes, dimension hierarchies and, dimension view metadata and associated reference data for the business dimensions 106.

The custom type library 110 can be formatted as an XML file for import into the performance management platform 114. The custom type library inherits from a generic type library of the performance management platform. The abstraction component 112 facilitates plugging and unplugging of the custom type library 110 into the performance management platform 114. The custom type library 110 facilitates localization of the industrial application 108 relative to regional and/or enterprise implementations. The abstraction component 112 facilitates the concurrent operation of multiple different custom type libraries for corresponding industrial applications.

Custom Dimensions can be created so that each application instance will have the dimensions created with the associated member properties, hierarchies and members. Members can be defined for an “All Members” hierarchy and any user defined hierarchy. Custom Models can be defined from a set of system defined dimensions, existing and new model properties and business rules. Rule templates can be created and added to the system. Report templates can be defined to match specific planning model types. When a custom model type is instantiated in an application, the report templates can be used to create forms and reports for those types.

A modeler is used as a tool to create and submit the custom types and save those types to the platform 114. In addition, the type library can be imported to any of multiple performance management platforms 114. After a type library is created, the type library can be quickly imported to any other system that creates all the defined system types. After importing the type library, any application or existing application is able to use these types.

Any supported web services support the custom types, and elevated security permission is defined for a modeler that can create, edit, and/or import custom types.

The system 100 and other embodiments described herein allow users to create industry vertical solutions on top of the performance management platform 114 which modeling types and application templates.

The creation and utilization of the custom type library 110 facilitates the predefining of the dimensions 106 and models 104 for an application. The dimensions 106 include defined attributes, hierarchies, and member views metadata, along with associated reference data for each dimension. For the models 104, the model type can be created, model properties set, and existing business rule and rule templates defined for the model.

Creating the infrastructure for custom type libraries allows for the development and distribution of focused vertical solutions (e.g., kits) that demonstrate how the custom type library 110 works, in addition to new planning scenarios for the performance management platform 114.

A business can be modeled using the defined types, which carry the majority of reusable business logic for a specific industry. The custom type library 110 reduces the time and cost to develop and deploy common industry vertical solutions. In each case, the business value is in the way the custom type library 110 can be quickly provided and easily installed on the performance management platform 114.

Moreover, the performance management platform 114 currently employs a modeler, which can be used to create, modify, save and import the custom type library 110.

Templates can be created for the custom type library 110 to be installed on the performance management platform 114. The templates can be reloaded or imported on any performance management platform.

Any user can create custom types based on the constraints listed below. A behavior not listed below is not accessible to the user. In one implementation, the user is not allowed to modify, extend, or change the behavior of any predefined performance management platform system type.

The user can create the following types. At the application level, the user can create calculation rule templates and form templates. For the model, the model type can be defined, the dimensions for the model, model properties (with default values), and calculation rules defined for the model. For the dimension, the dimension type can be defined, dimension attributes (and associated default values), dimension members, hierarchy definitions and members associated in a parent-child relationship for the hierarchy, and attribute groups for dimension attributes.

When a model type is defined for the system, any application that is created on the system has the ability to instantiate models which are derived from this model type. When defining the model, the model created will have all the underlying required dimensions, model properties, and defined calculation rules. All model types have scenario and time dimensions. If the user does not associate the scenario and time dimensions with a custom model, an error can be presented to the user when importing the custom type library 110. In addition, custom typed models include the same constraints on measure groups and multiple measures as generic models. Therefore, a customer is not able to add additional measures or/measure groups. After instancing a model based on a model type, the user can continue to modify the model to add additional customization just as if this was any other model that exists in the server.

On any model type which is created the user has the ability to change existing model property default values and add new model properties with associated default values. These properties can be used in model rules and/or rule templates.

Calculation rule templates are added to the system and available for any model which is used for the performance management platform. Rule templates are not validated when submitted to the server. When a rule template is used to create a rule instance for a model, the user has the ability to modify the rule to meet the exact needs for the model.

Calculation rule instances can be defined for each model. This means that if a rule instance exists for a model type, each time that model is instantiated the rule will be created for the model. If the rule is a valid rule, the rule will be deployed when the model site is deployed. If the rule is invalid, the modeler validation will fail and the rule not deployed to the data cube.

Dimension types can be defined as part of a custom type library 110. Dimension types are created into dimension instances for each application. Each dimension type has one corresponding instance. No predefined system dimension types can be created into another dimension type. Each time an application is created, each dimension type that is created in the type library exists once for each application. Dimension Attributes and associated default values

For any custom dimension, a number of dimension attributes can be created. When creating an attribute, the default value for that dimension can be set with the exception of ‘member of dimensions’. The default value that refers to a member of another dimension is not allowed to be set.

Each dimension type has the ability to create dimension members that exist when the dimension type is created. These dimension members can be edited or deleted after the dimension is created. Dimension types are validated for the correct type before being uploaded into the performance management platform 114. In one implementation, the total number of dimension members that are available in a type library is 5000.

Hierarchies can be defined for each dimension. These hierarchies can also include member relationships that exist for members based on the predefined dimension members for the dimension. Members of a hierarchy can be defined in any parent-child relationship and adhere to the excising validation rules for hierarchies.

On a dimension type, a user may choose to define an attribute that is based on values defined in an attribute group. This creates a dimension attribute the values of which may exist for one of the values in the attribute group. The disclosed architecture allows for creating attribute groups and values, and associating an attribute group for a dimension attribute.

In one implementation, no other applications may exist on the performance management platform 114 when installing the custom type library 110 and the custom type library 110 is imported in its entirety to ensure proper dependencies of all objects. In an alternative implementation, other applications can exist and a custom type library can be imported for each application.

When importing the custom type library 110, validation is performed to ensure that the custom type library 110 is correct and will not destabilize the platform 114. If an error is detected in the custom type library 110, an error is presented to the user that details the failure. When exporting the custom type library 110, the definition component 102 creates an XML file which contains the custom type library 110.

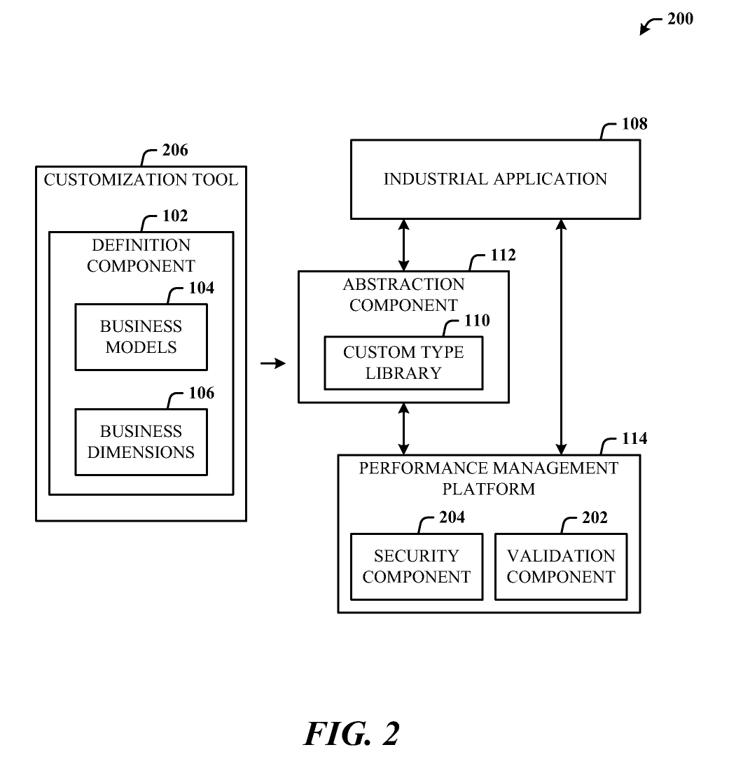

FIG. 2 illustrates an alternative system 200 that further employs a validation component 202. The validation component 202 validates correctness of the custom type library when importing the custom type library into the performance management platform 114. The system 200 can also includes a security component 204 for the security authentication of users authorized to import custom type libraries (e.g., business) into the performance management platform 114.

The definition component 102 is shown as part of a customization tool 206 that at least facilitates the definition and deployment of the custom type library 110 (e.g., business). For example, the tool 206 allows authors to define a model type, define dimensions for the model, model properties with default values, calculation rule templates, calculation rules defined for the model, define a dimension type, dimension attributes and associated default values, dimension members, hierarchy definitions and members associated in a parent-child relationship for the hierarchy, and attribute groups for dimension attributes. The tool 206 generates an XML file that can be used to be imported to performance management platform 114.

A schema for the custom type library 110 supports abstract types, sealed types, system-defined types, InstanceBase types and LinkedBase types, for example.

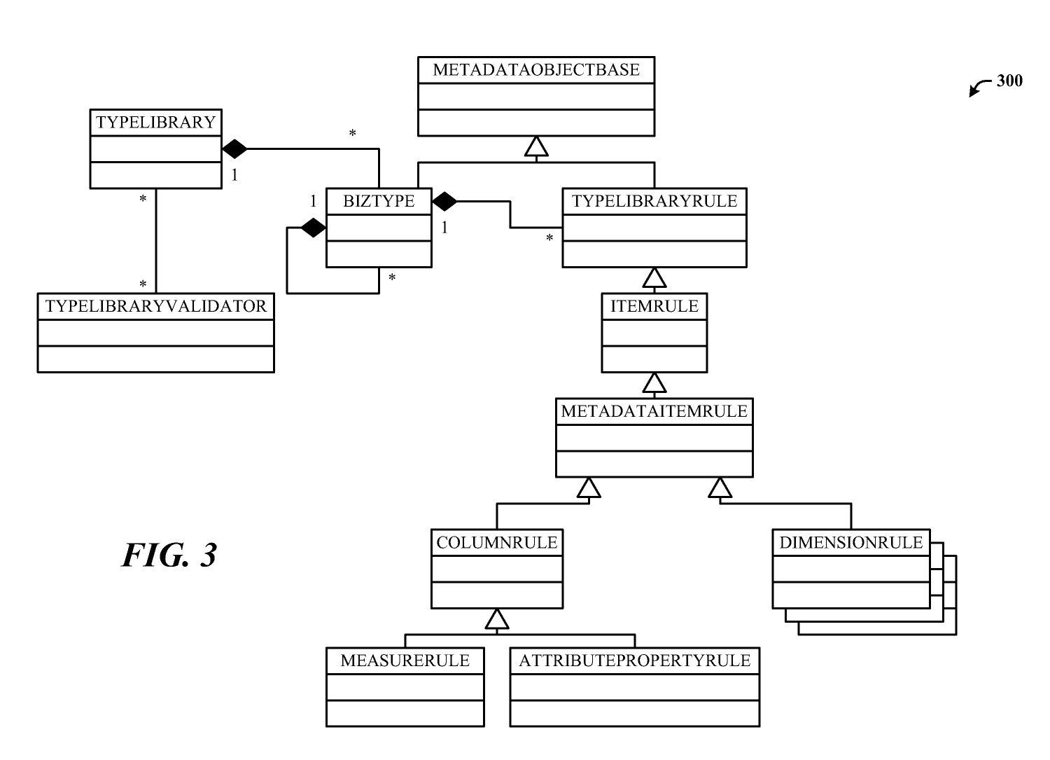

FIG. 3 illustrates a class diagram 300 for the custom type library content. The Type Library is used to create, validate, and provide type information to metadata, and is composed of two main components: Type Library content, and Type Library consumers (which use the Type Library content for various business needs such as creation, validation, etc.).

The Type Library content is an object-oriented design, for example, comprising two types of classes: BizType and TypeLibraryRule. Both types are BMO (business model object) classes. This allows the Type Library content classes to fully leverage the BMO infrastructure which provides support for persistence, localization, and serialization.

BizTypes represent a tree of metadata types where the deeper the travel down a particular branch, the more specialized the metadata type becomes. For example, a section of a full tree is provided below:

```
Generic Type
    Base Model
        Base Workflow Supported Model
            Base Assumption Model
                Exchange Rate Model
                Global Assumption Model
            Base Financial Model
                Financial Model without Shares
                Financial Model with Shares
            Generic Model
```

This section shows that a Financial Model with Shares is a specialized type of a Base Workflow Supported Model, which in turn is a specialized type of the Base Model.

TypeLibraryRules are attached (owned) by BizTypes. The owned rules describe the business logic associated with that BizType. The TypeLibraryRule is a base class for a collection of sub-classes. The rules are passive but implement an acyclic visitor pattern which allows for external code to implement business logic. Due to business logic, only certain BizTypes can contain rules, and only contain a subset of all the rules. For example, any BizType in the Base Model sub-branch can contain a DimensionRule; however, the BizType cannot contain a ModelSubsiteRule.

Each rule subclass includes additional properties that allow business logic to function. For example, the ColumnRule contains information about the data type of the column. Additional information may be provided by some of the consumer classes of the Type Library. Other rule classes can extend from the MetadataItemRule.

Note that the Type Library content is provided with a validator (TypeLibraryValidator class) the purpose of which is to ensure correctness of the Type Library content. For example, the validator validates that no BizType can create a circular reference by having a rule that instantiates itself. This situation can result in invalid business logic; thus, it is prevented.

Validation of an imported custom type library can include validating that there is no circular relationship between types (e.g., a BizType cannot have a TypeLibaryRule whose InstanceType is itself), and cannot have contradictory requirement categories for the same TypeLibraryRule (e.g., have a Required rule and a Not Allowed rule with the same InstanceType). Validation also ensures there are no orphan BizTypes (all BizTypes are able to walk up the tree to the Generic Type).

Validation also checks MetadataObjectBase information for BizTypes and TypeLibraryRules such as label, name, etc. InstanceLabel, InstanceName, InstanceDescription obey the rules of naming defined in MetadataObjectBase. Validation also ensures that an abstract BizType is not a leaf node, an abstract BizType does not inherit from a non-abstract type, a sealed BizType is not extended, that only custom TypeLibraryRules are extended, that InstanceType and LinkedType is part of the correct tree branch, and that a custom model type has only one measure group and one measure. Foreign Key Attribute rules are also validated to not have a null default value.

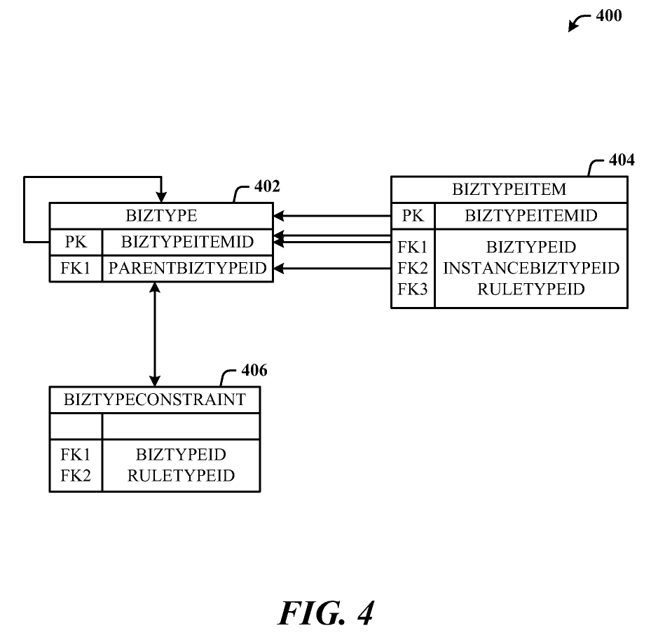

FIG. 4 illustrates table storage schema 400 for the type library. The type library is stored in three tables: BizType 402, BizTypeItems 404, and BizTypeConstraint 406 as described by the schema 400. The BizType table 402 lists all the types and the hierarchical structure of the type library. The BizTypeItem 404 table contains the TypeLibraryRules. The BizTypeConstraint table 406 describes the BizType and TypeLibraryRule ownership constraints. Client code can obtain the Type Library content by using a GetTypeLibraryContent( ) API provided by a metadata manager object, for example.

There are type library consumers (e.g., three) that implement various business logic: a TypeCreator, TypeValidator, and TypeConstraintChecker. The TypeCreator consumer is used to create metadata based on a particular BizType. When creating a piece of metadata, the TypeCreator ensures the type is a concrete type (not abstract). After that, the TypeCreator it creates an instance and then proceeds on a depth-first traversal of all the rules attached to that BizType. If the rule indicates a subsidiary object needs to be created, then the TypeCreator creates that instance and continues on that BizType's attached rules. In this way, creating a single BizType results in a full object hierarchy being created.

An example of this process is to create a model. Each model uses at least one measure group. The TypeCreator creates the model from the specific model BizType. One of the rules on the model BizType indicates that a measure group must be created; thus, the TypeCreator creates a measure group as well. Additionally, the measure group has rules indicating that one or more measures need to be created. The TypeCreator create those measures as well.

With respect to the TypeValidator, when loading metadata from the database or metadata that is submitted from a client application (e.g., BizModeler), the metadata needs to be valid. The TypeValidator uses the same set of rules as TypeCreator to verify that the metadata is complete and valid. For example, if a model type has a rule that indicates the model type should have a specific type of measure group, the TypeValidator ensures that the measure group exists. The TypeValidator performs the same depth-first traversal of rules as the TypeCreator, but instead of creating, the TypeValidator performs validations.

With respect to the TypeConstraintChecker, this consumer is used determine if a metadata object meets all the constraints of a BizType. For example, consider a calculation rule template that requires the Flow dimension. Further consider a model that does not have the Flow dimension; therefore, that model does not meet the constraints of that calculation rule template.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

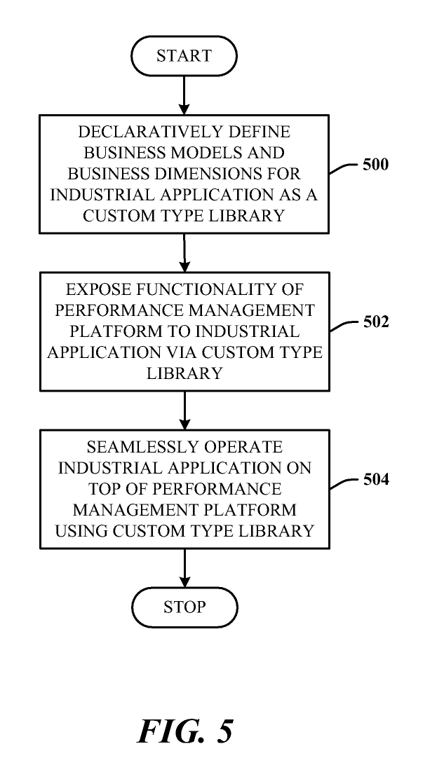

FIG. 5 illustrates a method of providing customized industrial application. At 500, business models and business dimensions are defined for an industrial application as a custom type library (e.g., business). At 502, functionality of the performance management platform is exposed to the industrial application via the custom type library. At 504, the industrial application is seamlessly operated on top of a performance management platform using the custom type library.

Authors of the customized type library can predefine dimensions and models for the industrial application, create dimensions which contain defined attributes, hierarchies, and member views metadata along with associated reference data for each dimension. For models, the authors can create model types, create and set model properties, and define business rules, rule templates, job templates and report templates for the model.

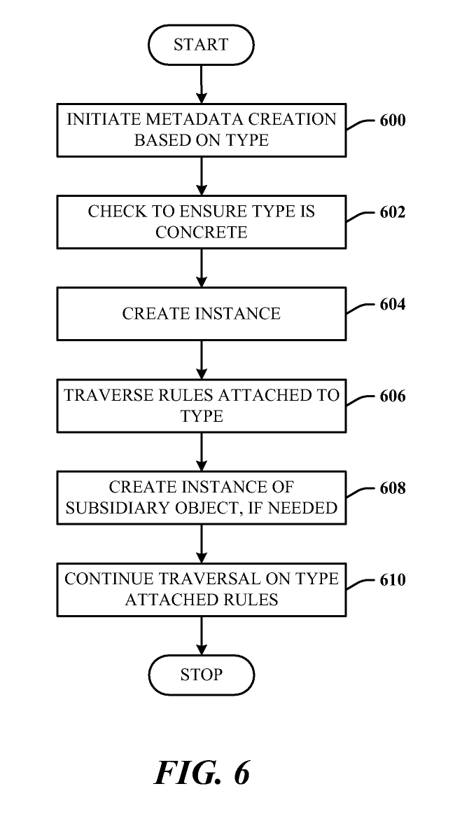

FIG. 6 illustrates a method of creating metadata based on a type. At 600, metadata creation is initiated based on a type. At 602, a check is performed to ensure the type is concrete. At 604, an instance is created. At 606, a depth-first traversal of all the rules attached to the type is performed. At 608, an instance is created if the rules indicate a subsidiary object needs to be created. At 610, traversal continues on the rule attached to the type. Thus, creating of a single type results in a full object hierarchy being created.

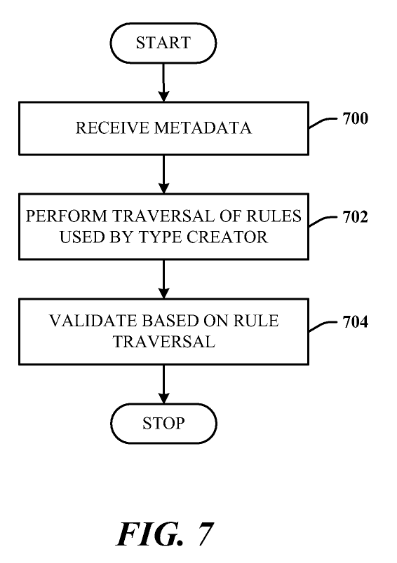

FIG. 7 illustrates a method of validating metadata when received. At 700, the metadata is received. At 702, traversal of rules is performed using the same rules as the type creator. At 704, validation is performed based on traversal of the rules.

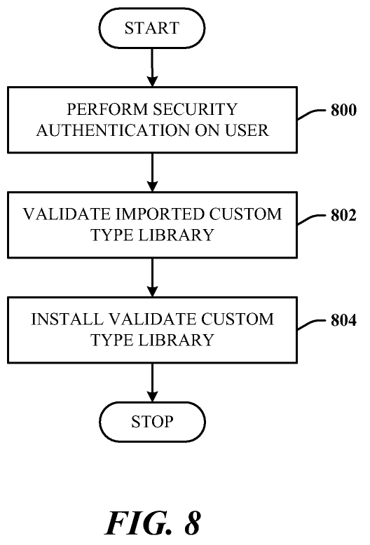

FIG. 8 illustrates a method of deploying a custom type library in accordance with the disclosed architecture. At 800, security authentication is initiated to ensure that only authorized users are allowed to import the custom type library. At 802, the imported custom type library is validated. At 804, once properly validated, the type library is installed. Other operations that can be performed include checking if an upgrade is needed on the current system.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

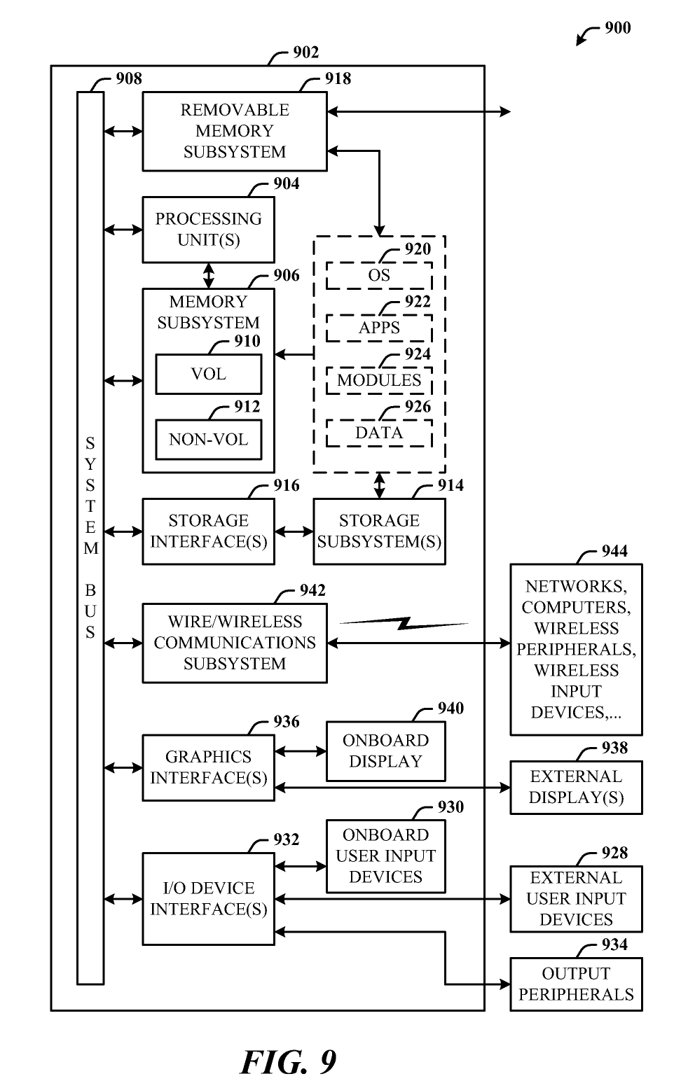

Referring now to FIG. 9, there is illustrated a block diagram of a computing system 900 operable to execute custom type library processes in accordance with the disclosed architecture. In order to provide additional context for various aspects thereof, FIG. 9 and the following discussion are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the memory subsystem 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes storage subsystem(s) 914 and storage interface(s) 916 for interfacing the storage subsystem(s) 914 to the system bus 908 and other desired computer components. The storage subsystem(s) 914 can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a removable memory subsystem 918 (e.g., flash drive form factor technology), and/or the storage subsystem(s) 914, including an operating system 920, one or more application programs 922, other program modules 924, and program data 926. Generally, programs include routines, methods, data structures, other software components, etc., that perform particular tasks or implement particular abstract data types. The one or more application programs 922, other program modules 924, and program data 926 can include definition component 102, the custom type library 110, and the tool 206.

Where the computer 902 functions as the performance management platform 114, the one or more application programs 922, other program modules 924, and program data 926 can include the abstraction layer 112, imported custom type library 110, validation component 202, security component 204, class diagram 300 and tables 400, on which the industrial solution 108 runs.

All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Computer readable media can be any available media that can be accessed by the computer 902 and includes volatile and non-volatile media, removable and non-removable media. For the computer 902, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP) using logical connections via a wire/wireless communications subsystem 942 to one or more networks and/or other computers. The other computers can include workstations, servers, routers, personal computers, microprocessor-based entertainment appliance, a peer device or other common network node, and typically include many or all of the elements described relative to the computer 902. The logical connections can include wire/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wire/wireless communication subsystem 942 (e.g., a network interface adapter, onboard transceiver subsystem, etc.) to communicate with wire/wireless networks, wire/wireless printers, wire/wireless input devices 944, and so on. The computer 902 can include a modem or has other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wire/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

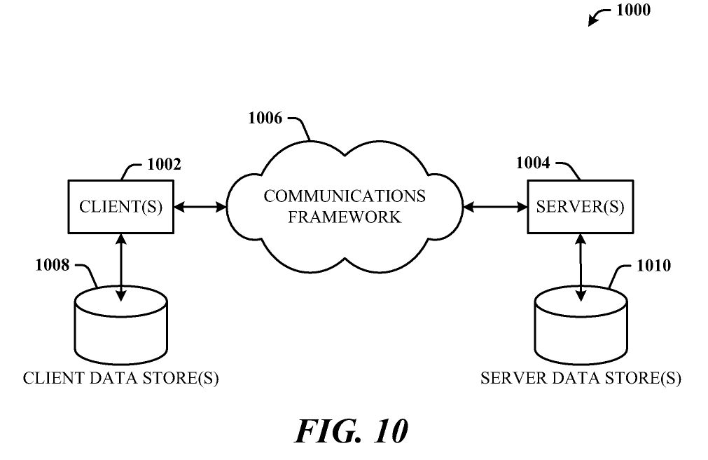

Referring now to FIG. 10, there is illustrated a schematic block diagram of a computing environment 1000 that supports a vertical industrial solution on a performance management platform. The environment 1000 includes one or more client(s) 1002. The client(s) 1002 can be hardware and/or software (e.g., threads, processes, computing devices). The client(s) 1002 can house cookie(s) and/or associated contextual information, for example.

The environment 1000 also includes one or more server(s) 1004. The server(s) 1004 can also be hardware and/or software (e.g., threads, processes, computing devices). The servers 1004 can house threads to perform transformations by employing the architecture, for example. One possible communication between a client 1002 and a server 1004 can be in the form of a data packet adapted to be transmitted between two or more computer processes. The data packet may include a cookie and/or associated contextual information, for example. The environment 1000 includes a communication framework 1006 (e.g., a global communication network such as the Internet) that can be employed to facilitate communications between the client(s) 1002 and the server(s) 1004.

Communications can be facilitated via a wire (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented business customization system, comprising:
a definition component for declaratively defining business models and business dimensions for an industrial application as a custom business type library; and
an abstraction component for operating the industrial application on top of a performance management platform by seamlessly exposing functionality of the performance management platform to the industrial application via the custom business type library.

2. The system of claim 1, wherein the definition component facilitates declaration of a model type, model properties, business rules, and business templates for the models.

3. The system of claim 1, wherein the definition component facilitates the declaration of dimension attributes, dimension hierarchies and, dimension view metadata and associated reference data.

4. The system of claim 1, wherein the custom business type library is an XML file that imports to the performance management platform.

5. The system of claim 1, wherein the custom business type library inherits from a generic type library of the performance management platform.

6. The system of claim 1, wherein the abstraction component facilitates plugging and unplugging of the custom business type library into the performance management platform.

7. The system of claim 1, wherein the custom business type library facilitates localization of the industrial application relative to a regional or enterprise implementation.

8. The system of claim 1, further comprising a validation component for validating correctness of the custom type library when importing the custom business type library into the performance management platform.

9. The system of claim 1, wherein the abstraction component facilitates concurrent operation of multiple custom business type libraries for corresponding industrial applications.

10. A computer-implemented business customization system, comprising:
a definition component for declaratively defining business models and business dimensions for an industrial application as a custom business type library;
an abstraction component for operating the industrial application on top of a performance management platform by seamlessly exposing functionality of the performance management platform to the industrial application via the custom business type library, the custom library inheriting from a generic type library of the performance management platform; and
a validation component for validating correctness of the custom business type library when interfacing the custom type library to the performance management platform.

11. The system of claim 10, wherein the definition component facilitates declaration of a model type, model properties, business rules, and business templates for the models and the declaration of dimension attributes, dimension hierarchies and, dimension view metadata and associated reference data.

12. The system of claim 10, wherein the custom business type library is an XML file that imports to the performance management platform.

13. The system of claim 10, wherein the abstraction component facilitates plugging and unplugging of the custom business type library into the performance management platform.

14. The system of claim 10, wherein the custom business type library is stored as tables that list types and hierarchical structure, rules, and ownership constraints.

15. A computer-implemented method of customized implementation of an industrial application, comprising:
declaratively defining business models and business dimensions for an industrial application as a custom business type library;
exposing functionality of the performance management platform to the industrial application via the custom business type library; and
seamlessly operating the industrial application on top of a performance management platform using the custom business type library.

16. The method of claim 15, wherein the business model is declaratively defined according to model type, model properties, business rules and business templates for the models.

17. The method of claim 15, wherein the business dimension is declaratively defined according to dimension attributes, dimension hierarchies and, dimension view metadata and associated reference data.

18. The method of claim 15, further comprising validating the custom business type library as part of importing the custom business type library into the performance management platform.

19. The method of claim 15, further comprising creating rules templates and report templates for the business models.

20. The method of claim 15, wherein the custom business type library inherits from a generic type library of the performance management platform.
